(19) United States
(12) Patent Application Publication
(10) Pub. No.: US 2013/0135910 A1
(43) Pub. Date: May 30, 2013

(54) POWER FACTOR CORRECTION APPARATUS, DC/DC CONVERTER, AND POWER SUPPLYING APPARATUS

(71) Applicants: Sang Hyun MIN, Yongin (KR); Koon Shik Cho, Seoul (KR); Jae Hyung Lee, Suwon (KR); Kwang Mook Lee, Suwon (KR)

(72) Inventors: Sang Hyun MIN, Yongin (KR); Koon Shik Cho, Seoul (KR); Jae Hyung Lee, Suwon (KR); Kwang Mook Lee, Suwon (KR)

(73) Assignee: SAMSUNG ELECTRO-MECHANICS CO., LTD.

(21) Appl. No.: 13/591,580

(22) Filed: Aug. 22, 2012

(30) Foreign Application Priority Data
Nov. 24, 2011 (KR) 10-2011-0123484

(51) Int. Cl. G05F 1/70; H02M 7/06

(52) U.S. Cl. 363/126; 323/205

(57) ABSTRACT

There are provided a power factor correction apparatus, a direct current/direct current (DC/DC) converter, and a power supplying apparatus, capable of preventing unstable feedback control due to a ripple component by controlling power switching based on a median value between a maximum value and a minimum value of a voltage level of the output power that is received as feedback. The power factor correction apparatus includes a power factor corrector switching input power and correcting a power factor thereof; and a controller detecting a voltage level of power factor-corrected power and controlling the switching of the power factor corrector, based on a median value between a maximum value and a minimum value of the voltage level of the power factor-corrected power detected for a predetermined period of time.

### CROSS-REFERENCE TO RELATED APPLICATIONS

This application claims the priority of Korean Patent Application No. 10-2011-0123484 filed on Nov. 24, 2011, in the Korean Intellectual Property Office, the disclosure of which is incorporated herein by reference.

### BACKGROUND OF THE INVENTION

1. Field of the Invention

The present invention relates to a power factor correction apparatus, a direct current/direct current (DC/DC) converter, and a power supplying apparatus, for controlling a voltage ripple component in output power.

2. Description of the Related Art

In general, to provide user satisfaction, various electronic equipments employ a power supply apparatus for performing corresponding operations.

Generally, a power supply apparatus largely includes a power factor correction apparatus and a direct current/direct current (DC/DC) converter.

A power factor correction apparatus allows a power factor to be approximately 100%. In this case, the power factor refers to a performance index related to current distortion and a phase difference between the voltage and current of input power.

When a power factor is 100%, the phases of the voltage and current are the same, and current distortion does not occur. Thus, a load serves as a pure resistance load, thereby using active power only.

In this case, since a power supply only needs to supply active power that is actually used, and does not have to supply reactive power, waste is eliminated in an aspect of power supply, thereby achieving efficiency.

Thus, a general power supplying apparatus may obtain a high power factor by employing a power factor correction apparatus.

In addition, a power factor correction apparatus may convert an alternating current (AC) power of 60 Hz into a DC power of about 400 V.

However, since DC power contains a ripple component of 120 Hz, corresponding to a level twice that of the magnitude of 60 Hz through rectifying AC power, feedback control becomes unstable and thus a desired power factor cannot be obtained.

Furthermore, a DC/DC converter switches input DC power, provides DC power having a desired voltage level in an electronic device, and is included in a power supplying apparatus. Similarly to in the power factor correction apparatus, output power contains a ripple component by switching the input DC power, and thus, feedback control becomes unstable.

### SUMMARY OF THE INVENTION

An aspect of the present invention provides a power factor correction apparatus, a direct current/direct current (DC/DC) converter, and a power supplying apparatus, which prevent unstable feedback control due to a ripple component by controlling power switching based on a median value between a maximum value and a minimum value of a voltage level of output power received as feedback in controlling power switching.

According to an aspect of the present invention, there is provided a power factor correction apparatus, including: a power factor corrector switching input power and correcting a power factor thereof; and a controller detecting a voltage level of power factor-corrected power and controlling the switching of the power factor corrector, based on a median value between a maximum value and a minimum value of the voltage level of the power factor-corrected power detected for a predetermined period of time.

The controller may include an analog to digital converter (ADC) receiving a divided voltage level obtained by dividing the voltage level of the power factor-corrected power, and converting the received divided voltage level into a digital signal; a median value calculator calculating the median value between the maximum value and the minimum value of the voltage level of the power factor-corrected power for a predetermined period of time, based on the digital signal from the ADC; and a switching controller controlling the switching of the power factor corrector, based on the median value from the median value calculator.

The median value calculator may include a maximum and minimum values detecting unit detecting a maximum value of the voltage level of the power factor-corrected power for a first predetermined period of time and detecting a minimum value of the voltage level of the power factor-corrected power for a second predetermined period of time, set to be different from the first predetermined period of time, based on the digital signal from the ADC; and a median value calculating unit calculating a median value between the maximum value and the minimum value from the maximum and minimum values detecting unit.

The median value calculating unit may include a first median value calculating unit outputting, as the median value, an average value of the maximum value detected for the first predetermined period of time and the minimum value detected for the second predetermined period of time; and a second median value calculating unit outputting, as the median value, an average value of the minimum value and a currently detected voltage value or an average value of the currently detected voltage value and the maximum value.

The median value calculator may further include a median value selecting unit selecting the median value of the first median value calculating unit or the second median value calculating unit, according to a comparison result between an output value of the power factor corrector and a predetermined threshold value.

The second median value calculating unit may apply a weight to the currently detected voltage value to calculate the average value thereof.

The power factor correction apparatus may further include a rectifier, rectifying alternating current (AC) power.

According to another aspect of the present invention, there is provided a direct current/direct current (DC/DC) converter, including: a DC/DC converting unit switching power input thereto and outputting DC power having a predetermined voltage level; and a controller detecting a voltage level of the DC power and controlling the switching of the DC/DC converting unit, based on a median value between a maximum value and a minimum value of the voltage level of the DC power, detected for a predetermined period of time.

According to another aspect of the present invention, there is provided a power supplying apparatus, including: a rectifier, rectifying alternating current (AC) power; a power factor corrector switching the rectified AC power and correcting a power factor thereof; a direct current/direct current (DC/DC) converting unit switching power factor-corrected power and outputting DC power having a predetermined voltage level; and a controller detecting a voltage level of the power factor-corrected power and controlling the switching of the power factor corrector, based on a median value between a maximum value and a minimum value of the voltage level of the power factor-corrected power detected for a predetermined period of time.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic structural diagram of a power factor correction apparatus according to an embodiment of the present invention;

FIG. 2 is a schematic block diagram of a median value calculator included in the power factor correction apparatus according to the embodiment of the present invention;

FIG. 3 is a timing chart for explaining an operation of the power factor correction apparatus according to the embodiment of the present invention;

FIG. 4 is a flowchart of an operation of a switching controller included in a power factor correction apparatus, according to an embodiment of the present invention;

FIGS. 5 through 7 are signal graphs according to an operation of the switching controller shown in FIG. 4;

FIG. 8 is a schematic structural diagram of a direct current/direct current (DC/DC) converter according to an embodiment of the present invention; and

FIG. 9 is a schematic structural diagram of a power supplying apparatus according to an embodiment of the present invention.

### DETAILED DESCRIPTION OF THE INVENTION

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

When a component is mentioned as being “connected” to another component, this may mean that it is directly connected to other component, but it is to be understood that another component may exist therebetween.

In addition, unless explicitly described otherwise, “comprising” any components will be understood to imply the inclusion of other components but not the exclusion of any other components.

Embodiments of the present invention will now be described in detail with reference to the accompanying drawings.

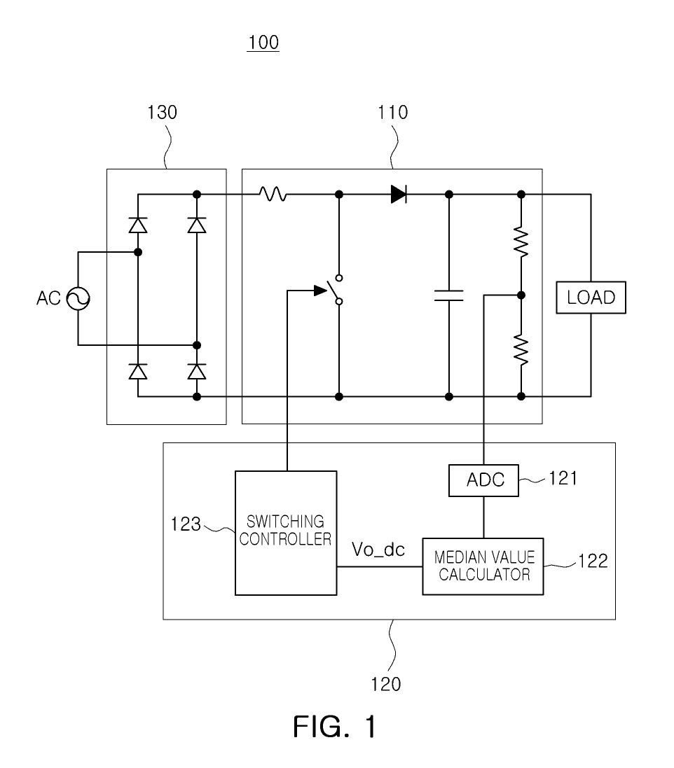

FIG. 1 is a schematic structural diagram of a power factor correction apparatus according to an embodiment of the present invention.

Referring to FIG. 1, a power factor correction apparatus 100 may include a power factor corrector 110 and a controller 120 and may further include a rectifier 130.

The power factor corrector 110 may switch input power to adjust a phase difference between current and voltage of the power, thereby correcting a power factor.

To this end, as shown in FIG. 1, the power factor corrector 110 may include an inductor storing or discharging energy, a switch switching power of the inductor according to a switching control signal, a diode forming a transfer path of the switched power, and a capacitor stabilizing the power transferred through the transfer path, and may include a voltage dividing resistor dividing a voltage level of the power factor-corrected power in order to detect the power factor-corrected power.

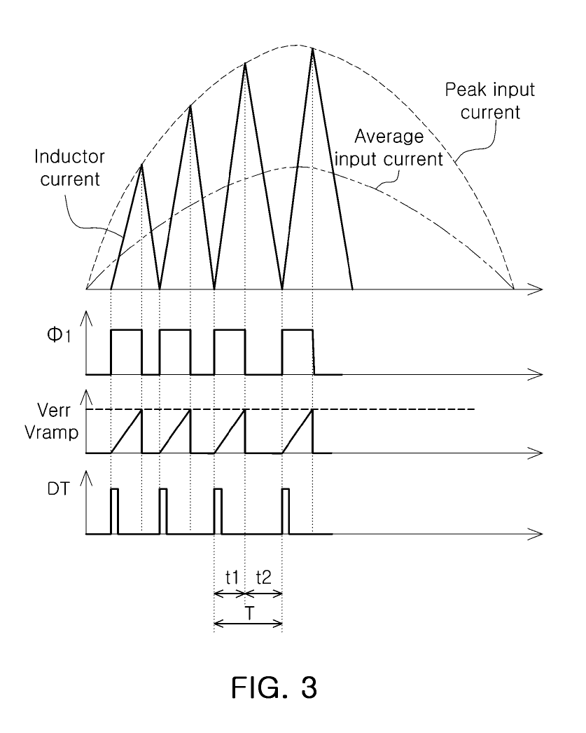

FIG. 3 is a timing chart for explaining an operation of the power factor correction apparatus according to the embodiment of the present invention.

Referring to FIG. 3, in general, in order to control switching of the power factor corrector, the divided voltage level may be converted into a digital signal to influence the switching control.

An instantaneous error value Err between a current voltage value Vo_sens and a target voltage value (Vref=400V*sensing gain) may be obtained according to Equation 1 below:

Err=Vref−Vo_{—}sens [Equation 1]

The instantaneous error value Err obtained according to Equation 1 may be converted into a convergence error value Verr.

The convergence error value Verr may be defined according to Equation 2 below:

Verr(n)+Verr(n−1)+Gp*(Err(n)−Az*Err(n−1)) [Equation 2]

wherein n is a natural number.

In Equation 2, the convergence error value Verr(n) is an error value that converges at a present time, Verr (n−1) is an error value that converges one clock earlier, Gp is a proportional control gain, and Az is a coefficient in association with a position of zero of a transfer function.

The transfer function may be represented by Gvc(z) defined according to Equation 3 below:

Gvc(z)=Gp*(z−Az)/(z−1) [Equation 3]

That is, when an output voltage is equal to a target voltage by controlling an on/off operation of the switch of the power factor corrector 110, the instantaneous error value Err may be ‘0’. Then, the convergence error value Verr may no longer increase or decrease and may be constantly maintained to an error value that converges at a present time.

As shown in FIG. 3, a turn-on time t1 of the switch may be determined as a period of time from a point at which a Vramp count value having an internal-fixed inclination S increases, according to lapse of time to a point at which the Vramp count value is equal to the convergence error value Verr. Thus, as the convergence error value Verr increases, the turn-on time t1 may be increased. As the convergence error value Verr reduces, the turn-on time t1 may be reduced.

A turn-off time t2 of the switch may be determined as a time when a current value of the inductor is ‘0’.

When the on/off operation of the switch is controlled, an average input current and an input voltage may be defined according to Equation 4 below:

Iave=1/2*Ipeak=1/2*(Vin/L)*t1=Vin*(Verr/(2*L*S)) [Equation 4]

In Equation 4, lave is an average input current, Ipeak is an input peak current, Vin is an input voltage, S is an inclination of Vramp, and L is inductance of the inductor.

As shown in Equation 4, when the convergence error value Verr is a constant, since L and S are constants, an equation “average input current=input voltage*constant” is satisfied. Thus, the average input current may have the same phase and waveform as those of the input voltage, thereby obtaining a power factor of 100%.

However, since the output voltage of the power factor corrector 110 contains a ripple component corresponding to a double frequency of a frequency of an input power voltage, the instantaneous error value Err may not permanently converge to ‘0’ and may constantly fluctuate. Thus, the convergence error value Verr may also fluctuate, thereby deteriorating power factor properties.

To this end, the controller 120 may include an analog to digital converter (ADC) 121, a median value calculator 122, and a switching controller 123.

The ADC 121 may receive the current voltage value Vo_sens obtained by dividing the voltage level of the power factor-corrected power by the power factor corrector 110 as feedback power, may convert the current voltage value Vo_sens into a digital signal, and may transmit the digital signal to the median value calculator 122.

The median value calculator 122 may calculate a median value Vo_dc between a maximum value and a minimum value of a voltage level of the digital signal for a predetermined period of time and may transmit the median value Vo_dc to the switching controller 123.

The switching controller 123 may control the switching of the power factor corrector 110, based on the median value Vo_dc transmitted from the median value calculator 122.

The rectifier 130 may rectify the alternating current (AC) power input thereto to provide the rectified AC power to the power factor corrector 110. To this end, the rectifier 130 may include bridge diodes, as shown in FIG. 1.

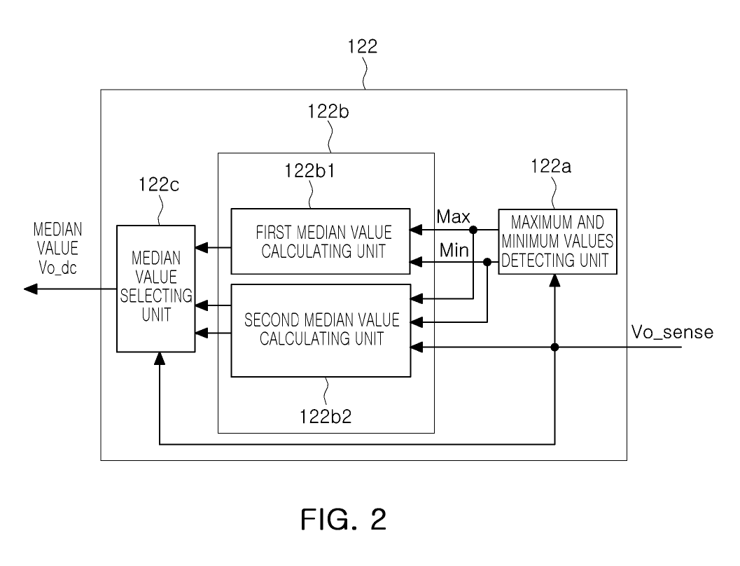

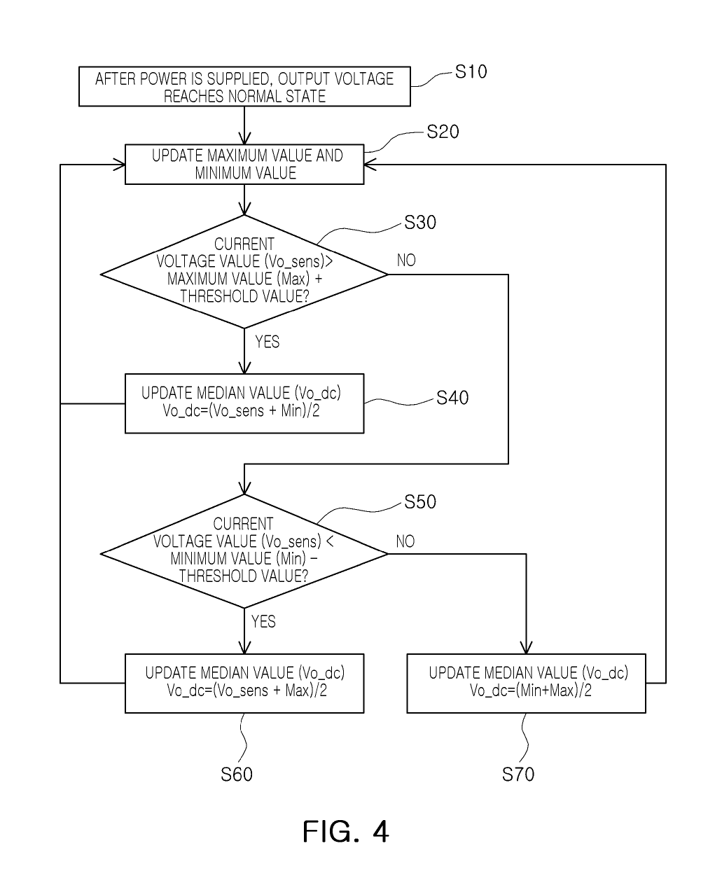

FIG. 2 is a schematic block diagram of a median value calculator included in the power factor correction apparatus according to the embodiment of the present invention. FIG. 4 is a flowchart of an operation of a switching controller included in a power factor correction apparatus, according to an embodiment of the present invention.

Referring to FIGS. 2 and 4, the median value calculator 122 may include a maximum and minimum values detecting unit 122a, a median value calculating unit 122b, and a median value selecting unit 122c.

The maximum and minimum values detecting unit 122a may detect a maximum value and a minimum value of a voltage level of a digital signal for a predetermined period of time. That is, the maximum and minimum values detecting unit 122a may detect the maximum value of the voltage level of the digital signal for a first predetermined period of time and may detect the minimum value of the voltage level of the digital signal for a second predetermined period of time after the first predetermined period of time.

For example, when a frequency of the input AC power is 50 Hz or 60 Hz, a ripple may exist at 100 Hz to 120 Hz. Thus, about ½ of a period of time corresponding to a frequency of 100 Hz to 120 Hz may be set as the first predetermined period of time and a voltage value may be detected. Thus, when a voltage value detected for about ¼ of a period of time corresponding to a frequency of 100 Hz to 120 Hz is verified for a period of time corresponding to the remaining ¼, if the detected voltage value is a highest voltage value, the detected voltage value may be set as the maximum value of the voltage level. Similarly, the remaining ½ of a period of time corresponding to a frequency of 100 Hz to 120 Hz may be set as the second predetermined period of time and a voltage value may be detected. Thus, when a voltage value detected for about ¼of a period of time corresponding to a frequency of 100 Hz to 120 Hz is verified for a period of time corresponding to the remaining ¼, if the detected voltage value is a lowest voltage value, the detected voltage value may be set as the minimum value of the voltage level.

The detected maximum value and the minimum value of the voltage level may be continually updated by periodically detecting voltage values for the first predetermined period of time and the second predetermined period of time (S10 and S20). Thus, a median value may also be periodically updated.

The median value calculating unit 122b may calculate an average value of the detected maximum value and the minimum value and may provide the average value as the median value.

To this end, the median value calculating unit 122b may include a first median value calculating unit 122b1 calculating the average value of the detected maximum value and the minimum value. The first median value calculating unit 122b1 may provide the average value of the detected maximum value and the minimum value as the median value.

Due to fluctuation in an input voltage, fluctuation in an input frequency, and fluctuation in an output load, the power factor-corrected power may remarkably change.

Thus, the median value calculating unit 122b may further include a second median value calculating unit 122b2.

In order to respond the remarkable change of the power factor-corrected power, the second median value calculating unit 122b2 may calculate an average value of the current voltage value Vo_sens and the detected maximum value or an average value of the current voltage value Vo_sens and the detected minimum value, and may provide the average value as the median value.

Furthermore, in order to promptly respond the remarkable change of the power factor-corrected power, the second median value calculating unit 122b2 may apply a weight to the current voltage value Vo_sens and may provide, as the median value, the average value of the detected maximum value or the minimum value and the current voltage value Vo_sens to which the weight is applied. For example, in order to promptly respond the remarkable change of the power factor-corrected power, the average value may be set as “(maximum value (or minimum value)+2*current voltage value Vo_sens)/3” and may be provided as the median value. The average value obtained using a weight may promptly respond to the remarkable change of the power factor-corrected power. However, since the average value obtained using a weight may be greatly affected by noise, the setting of an appropriate weight may be required.

When the power factor-corrected power remarkably changes, the median value selecting unit 122c may select the median value of the second median value calculating unit 122b2 and may provide the median value to the switching controller 123. Otherwise, the median value selecting unit 122c may select the median value of the first median value calculating unit 122b1 and may provide the median value to the switching controller 123. The median value selecting unit 122c may determine whether the power factor-corrected power changes significantly, according to whether the current voltage value Vo_sens is greater than a predetermined threshold value or is smaller than the predetermined threshold value. In more detail, when the current voltage value Vo_sens is greater than ‘maximum value+threshold value’, the median value may be updated, and the average value of the detected minimum value and the current voltage value Vo_sens of the second median value calculating unit 122b2 may be selected as the median value and be provided to the switching controller 123 (S30 and S40). When the current voltage value Vo_sens is smaller than ‘minimum value−threshold value’, the average value of the detected maximum value and the current voltage value Vo_sens of the second median value calculating unit 122b2 may be selected as the median value and be provided to the switching controller 123 (S50 and S60). When the current voltage value Vo_sens is greater than the ‘minimum value−threshold value’ and is smaller than the ‘maximum value+threshold value’, the median value of the first median value calculating unit 122b1 may be selected and provided to the switching controller 123 (S70).

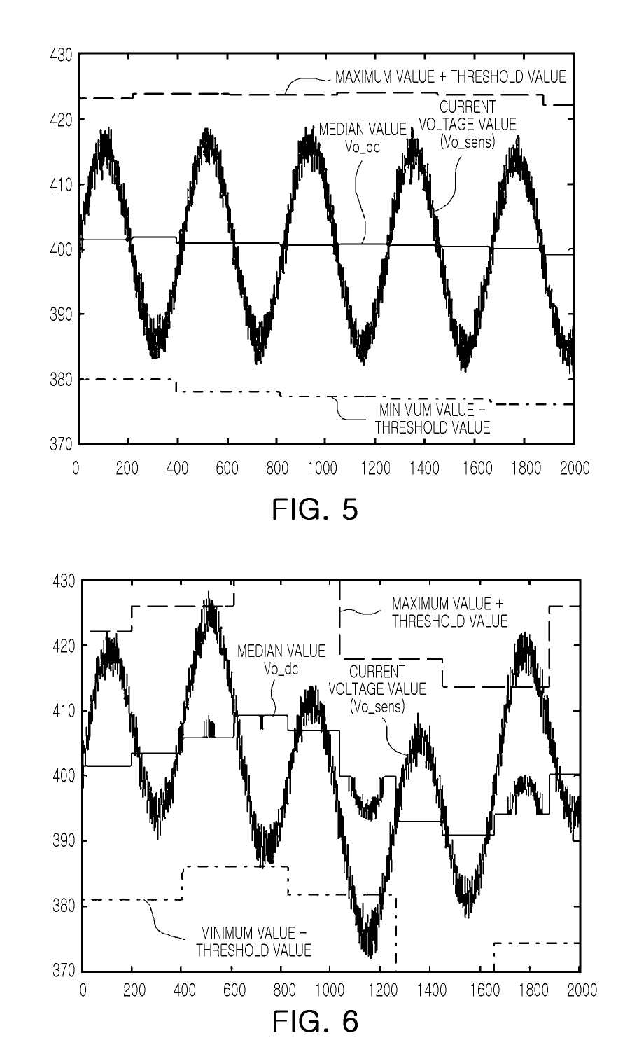

FIGS. 5 through 7 are signal graphs according to an operation of the switching controller shown in FIG. 1.

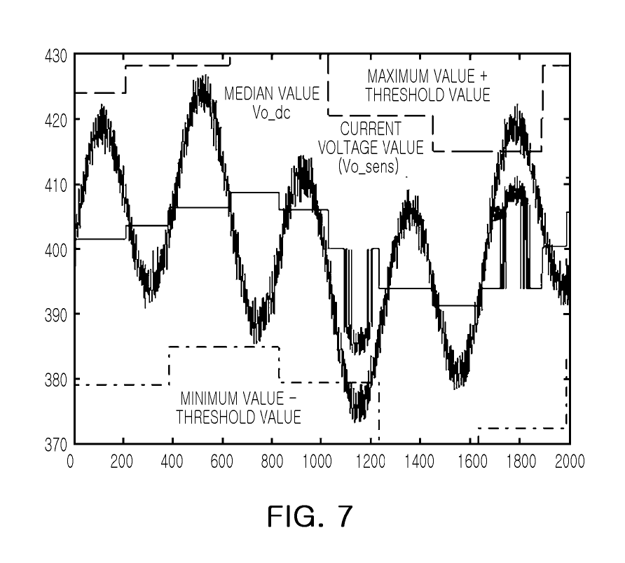

As shown in FIG. 5, it can be seen that an average value of the maximum value and the minimum value is provided as a median value. As shown in FIG. 6 or 7, when power factor-corrected power remarkably changes, an average value of the current voltage value Vo_sens and the detected maximum value or an average value of the current voltage value Vo_sens and the detected minimum value is calculated and provided as the median value. However, it can be seen that an average value of a current voltage value obtained by applying a weight to the current voltage value Vo_sens and the detected maximum value or the minimum value is provided as a median value, whereby the remarkable change of the power factor-corrected power influences the median value.

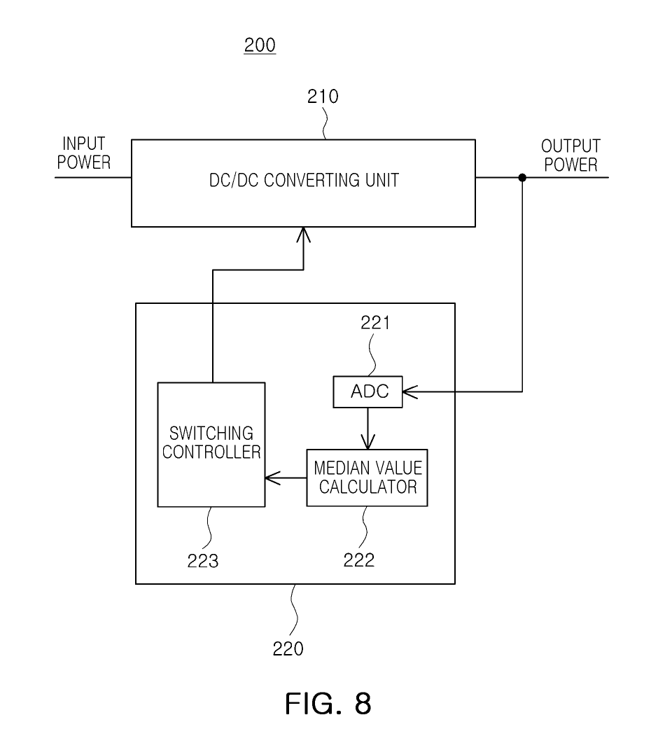

FIG. 8 is a schematic structural diagram of a direct current/direct current (DC/DC) converter according to an embodiment of the present invention.

Referring to FIG. 8, a DC/DC converter 200 may include a DC/DC converting unit 210 and a controller 220.

The DC/DC converting unit 210 may switch power input thereto so as to convert the input power into a predetermined DC power. The controller 220 may receive the power output from the DC/DC converting unit 210 as feedback and may control the switching of the DC/DC converting unit 210.

Since the DC/DC converting unit 210 may switch the input power, the output power may contain a ripple component. Thus, feedback control of the DC/DC converting unit 210 may be unstable. In this case, the controller 220 may control power switching according to a median value between a maximum value and a minimum value of the output power, thereby preventing the unstable feedback control of the DC/DC converting unit 210.

The detailed description of the controller 220 is the same as that of the controller 120 of FIGS. 1 and 2 and thus will not be repeated herein.

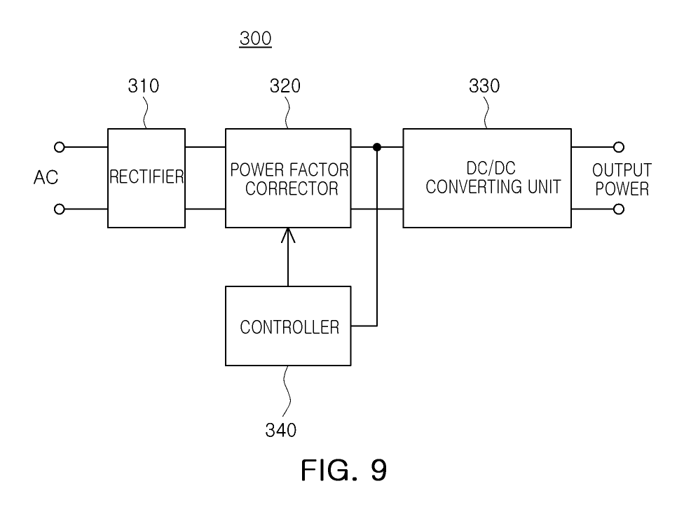

FIG. 9 is a schematic structural diagram of a power supplying apparatus according to an embodiment of the present invention.

Referring to FIG. 9, a power supplying apparatus 300 may include a rectifier 310, a power factor corrector 320, a DC/DC converting unit 330, and a controller 340.

The configurations and operations of the rectifier 310, the power factor corrector 320, and the controller 340 of the power supplying apparatus 300 are the same as in FIGS. 1 through 7, and thus the detailed description thereof will not be repeated herein. The detailed description of the DC/DC converting unit 330 is the same as in FIG. 8 and thus will not be repeated herein.

As set forth above, according to the embodiments of the present invention, in controlling power switching by receiving output power as feedback, the power switching is controlled based on a median value between a maximum value and a minimum value of a voltage level of the output power that is received as feedback, whereby unstable feedback control due to a ripple component may be prevented.

While the present invention has been shown and described in connection with the embodiments, it will be apparent to those skilled in the art that modifications and variations can be made without departing from the spirit and scope of the invention as defined by the appended claims.

What is claimed is:

1. A power factor correction apparatus, comprising:
a power factor corrector switching input power and correcting a power factor thereof; and
a controller detecting a voltage level of power factor-corrected power and controlling the switching of the power factor corrector, based on a median value between a maximum value and a minimum value of the voltage level of the power factor-corrected power detected for a predetermined period of time.

2. The power factor correction apparatus of claim 1, wherein the controller includes:
an analog to digital converter (ADC) receiving a divided voltage level obtained by dividing the voltage level of the power factor-corrected power, and converting the received divided voltage level into a digital signal;
a median value calculator calculating the median value between the maximum value and the minimum value of the voltage level of the power factor-corrected power for a predetermined period of time, based on the digital signal from the ADC; and
a switching controller controlling the switching of the power factor corrector, based on the median value from the median value calculator.

3. The power factor correction apparatus of claim 2, wherein the median value calculator includes:
a maximum and minimum values detecting unit detecting a maximum value of the voltage level of the power factor-corrected power for a first predetermined period of time and detecting a minimum value of the voltage level of the power factor-corrected power for a second predetermined period of time, set to be different from the first predetermined period of time, based on the digital signal from the ADC; and
a median value calculating unit calculating a median value between the maximum value and the minimum value from the maximum and minimum values detecting unit.

4. The power factor correction apparatus of claim 3, wherein the median value calculating unit includes:
a first median value calculating unit outputting, as the median value, an average value of the maximum value detected for the first predetermined period of time and the minimum value detected for the second predetermined period of time; and
a second median value calculating unit outputting, as the median value, an average value of the minimum value and a currently detected voltage value or an average value of the currently detected voltage value and the maximum value.

5. The power factor correction apparatus of claim 4, wherein the median value calculator further includes a median value selecting unit selecting the median value of the first median value calculating unit or the second median value calculating unit, according to a comparison result between an output value of the power factor corrector and a predetermined threshold value.

6. The power factor correction apparatus of claim 4, wherein the second median value calculating unit applies a weight to the currently detected voltage value to calculate the average value thereof.

7. The power factor correction apparatus of claim 1, further comprising a rectifier, rectifying alternating current (AC) power.

8. A direct current/direct current (DC/DC) converter, comprising:
a DC/DC converting unit switching power input thereto and outputting DC power having a predetermined voltage level; and
a controller detecting a voltage level of the DC power and controlling the switching of the DC/DC converting unit, based on a median value between a maximum value and a minimum value of the voltage level of the DC power, detected for a predetermined period of time.

9. The DC/DC converter of claim 8, wherein the controller includes:
an analog to digital converter (ADC) receiving a divided voltage level obtained by dividing the voltage level of the DC power, and converting the received divided voltage level into a digital signal;
a median value calculator calculating the median value between the maximum value and the minimum value of the voltage level of the DC power for a predetermined period of time, based on the digital signal from the ADC; and
a switching controller controlling the switching of the DC/DC converting unit, based on the median value from the median value calculator.

10. The DC/DC converter of claim 9, wherein the median value calculator includes:
a maximum and minimum values detecting unit detecting a maximum value of the voltage level of the DC power for a first predetermined period of time and detecting a minimum value of the voltage level of the DC power for a second predetermined period of time, set to be different from the first predetermined period of time, based on the digital signal from the ADC; and
a median value calculating unit calculating a median value between the maximum value and the minimum value from the maximum and minimum values detecting unit.

11. The DC/DC converter of claim 10, wherein the median value calculating unit includes:
a first median value calculating unit outputting, as the median value, an average value of the maximum value detected for the first predetermined period of time and the minimum value detected for the second predetermined period of time; and
a second median value calculating unit outputting, as the median value, an average value of the minimum value and a currently detected voltage value or an average value of the currently detected voltage value and the maximum value.

12. The DC/DC converter of claim 11, wherein the median value calculator further includes a median value selecting unit selecting the median value of the first median value calculating unit or the second median value calculating unit, according to a comparison result between the voltage level of the DC power of the DC/DC converting unit and a predetermined threshold value.

13. The DC/DC converter of claim 11, wherein the second median value calculating unit applies a weight to the currently detected voltage value to calculate the average value thereof.

14. A power supplying apparatus, comprising:
a rectifier, rectifying alternating current (AC) power;
a power factor corrector switching the rectified AC power and correcting a power factor thereof;
a direct current/direct current (DC/DC) converting unit switching power factor-corrected power and outputting DC power having a predetermined voltage level; and
a controller detecting a voltage level of the power factor-corrected power and controlling the switching of the power factor corrector, based on a median value between a maximum value and a minimum value of the voltage level of the power factor-corrected power detected for a predetermined period of time.

15. The power supplying apparatus of claim 14, wherein the controller includes:
an analog to digital converter (ADC) receiving a divided voltage level obtained by dividing the voltage level of the power factor-corrected power, and converting the received divided voltage level into a digital signal;
a median value calculator calculating the median value between the maximum value and the minimum value of the voltage level of the power factor-corrected power for a predetermined period of time, based on the digital signal from the ADC; and
a switching controller controlling the switching of the power factor corrector, based on the median value from the median value calculator.

16. The power supplying apparatus of claim 15, wherein the median value calculator includes:
a maximum and minimum values detecting unit detecting a maximum value of the voltage level of the power factor-corrected power for a first predetermined period of time and detecting a minimum value of the voltage level of the power factor-corrected power for a second predetermined period of time, set to be different from the first predetermined period of time, based on the digital signal from the ADC; and
a median value calculating unit calculating a median value between the maximum value and the minimum value from the maximum and minimum values detecting unit.

17. The power supplying apparatus of claim 16, wherein the median value calculating unit includes:
a first median value calculating unit outputting, as the median value, an average value of the maximum value detected for the first predetermined period of time and the minimum value detected for the second predetermined period of time; and
a second median value calculating unit outputting, as the median value, an average value of the minimum value and a currently detected voltage value or an average value of the currently detected voltage value and the maximum value.

18. The power supplying apparatus of claim 17, wherein the median value calculator further includes a median value selecting unit selecting the median value of the first median value calculating unit or the second median value calculating unit, according to a comparison result between an output value of the power factor corrector and a predetermined threshold value.

19. The power supplying apparatus of claim 17, wherein the second median value calculating unit applies a weight to the currently detected voltage value to calculate the average value thereof.
